(19) United States
(12) Patent Application Publication
(10) Pub. No.: US 2025/0180825 A1
(43) Pub. Date: Jun. 5, 2025

(54) FERRULE, METHOD FOR MANUFACTURING FERRULE, FERRULE-EQUIPPED FIBER RIBBON, AND METHOD FOR MANUFACTURING FERRULE-EQUIPPED FIBER RIBBON

(71) Applicant: FURUKAWA ELECTRIC CO., LTD., Tokyo (JP)

(72) Inventors: Yoshiyuki Wakamiya, Tokyo (JP); Tsunetoshi Saito, Tokyo (JP); Masayoshi Tsukamoto, Tokyo (JP); Kengo Watanabe, Tokyo (JP); Masahiro Handa, Tokyo (JP)

(21) Appl. No.: 19/036,098

(22) Filed: Jan. 24, 2025

Related U.S. Application Data
(63) Continuation of application No. PCT/JP2023/023083, filed on Jun. 22, 2023.

(30) Foreign Application Priority Data
Jul. 28, 2022 (JP) 2022-120604

(51) Int. Cl. G02B 6/38

(52) U.S. Cl. CPC G02B 6/3854; G02B 6/381; G02B 6/3838; G02B 6/3861; G02B 6/3885; G02B 6/3889

(57) ABSTRACT

An optical connector ferrule is a member inside which an optical fiber is secured, and a tip side thereof serves as a connection end surface for an optical fiber. The optical connector ferrule is formed by injection molding, for example, and is formed from polyphenylene sulfide (PPS) resin that contains a filling material (e.g., inorganic fibers or a filler). An internal space is communicated with the tip side of the optical connector ferrule and serves as a hole into which the optical fiber is inserted. Here, the 260° C.×1 minute shrinkage factor of the optical connector ferrule in the present embodiment is 0.13% or less.

### TECHNICAL FIELD

The present invention relates to an optical connector ferrule inside which optical fibers are to be fixed, and the like.

### BACKGROUND OF THE INVENTION

For connecting optical fibers with each other, various types of optical connectors and connector ferrules have been proposed. For example, an MT-type ferrule has, on a connection end surface side, a pair of holes into which guide pins can be inserted, with end surfaces of optical fibers being exposed between the guide pins. Inside such the MT-type ferrule, optical fibers are fixed with adhesive. Thus, a window for injecting the adhesive inside is formed at a part of the ferrule, and the adhesive is injected from the injection window with the optical fibers being disposed inside such that the optical fibers are fixed to the ferrule (Japanese Unexamined Patent Application Publication No. 2-146508 (JP-A-2-146508) and Japanese Unexamined Patent Application Publication No. 2002-328264 (JP-A-2002-328264), for example).

In recent years, there has been an increasing demand for application of optical wiring to electric circuit boards. In a manufacturing process of an electric circuit board, there is a process called solder reflow where a product is left at a high temperature of 230-260° C., and a ferrule, which is an optical connector component, is to have solder reflow resistance. However, a conventional MT ferrule thermally shrinks with respect to the solder reflow temperature (230-260° C.), and thus dimensional accuracy required for the ferrule cannot be maintained. In addition, due to a thermal expansion difference between the optical fibers inside the ferrule and epoxy adhesive for bonding the optical fibers, end surfaces of the optical fibers are retracted into the ferrule after going through the solder reflow, which makes it impossible for so-called PC (physical contact) connection.

In contrast, Japanese Unexamined Patent Application Publication No. 2021-24971 (JP-A-2021-24971) has proposed a method that provides heat resistance by changing base resin of a material from commonly used polyphenylene sulfide (PPS) to polyetheretherketone resin (PEEK).

However, PEEK resin costs twice the cost of PPS resin in general, and molding performance and availability thereof are also inferior to those of PPS. Also, when being connected with a conventional ferrule made of PPS, difference in thermal expansion coefficients and water absorption rates may affect connection characteristics. Also, the issue of retraction of optical fibers after solder reflow still remains unsolved.

### SUMMARY OF THE INVENTION

The present invention was made in view of such problems. It is an object of the present invention to provide an optical connector ferrule and the like in which effects in a solder reflow process can be suppressed without using special resin material.

To achieve the above object, a first aspect of the present invention is an optical connector ferrule inside which an optical fiber is fixed, the ferrule having a tip side serving as a connection end surface. The ferrule includes a hole into which the optical fiber is to be inserted and a pair of guide holes into which guide pins for positioning are to be inserted. The ferrule is formed from a resin composition, which is thermoplastic resin added with a filling material including at least inorganic particles. A shrinkage factor of the ferrule at 260° C.×1 minute is 0.13% or less.

A linear expansion coefficient of the resin composition is preferably 3.0×10⁻⁵/° C. or less.

It is preferable that the thermoplastic resin includes PPS resin as a main component, and the inorganic particles include spherical silica.

A content rate of the inorganic particles in the resin composition is preferably 60 mass % or more and 80 mass % or less.

A particle size distribution D100 of the inorganic particles is preferably 60 μm or less. The resin composition may further include carbon black as carbon particles.

A dent section may be formed in an outer surface of the ferrule on a side that is opposite to a side in which an adhesive injection window is formed.

According to the first aspect of the present invention, the shrinkage factor of the ferrule at 260° C.×1 minute is 0.13% or less, and thus the ferrule does not shrink excessively in a reflow process and dimensional accuracy can be maintained.

Also, if the linear expansion coefficient of the resin composition is 3.0×10⁻⁵/° C. or less, it is possible to suppress dimensional deformation at the time of heat treatment with more certainty.

Also, by using PPS resin as the main component, the same resin materials as the conventional ferrule materials can be applied. At this time, if the inorganic particles are spherical silica, molding performance is good.

Also, if the content rate of the inorganic particles in the resin composition is 60 mass % or more and 80 mass % or less, high strength and dimensional accuracy can be obtained.

Similarly, by making the particle size distribution D100 of the inorganic particles 60 μm or less, high strength and dimensional accuracy can be obtained with more certainty.

By making the resin composition include carbon black as carbon particles, inner defects such as foreign substances are less noticeable.

Also, by forming the dent section on the outer surface of the ferrule on the side that is opposite to the side in which the adhesive injection window is formed, imbalance between an amount of resin at an upper part and an amount of resin at a lower part at the time of injection molding can be suppressed, which can make a flow of the resin at the time of injection molding uniform. As a result, the ferrule can be molded with high dimensional accuracy.

A second aspect of the present invention is a method for manufacturing the ferrule according to the first aspect of the present invention. The method includes a heat treatment process, after molding the ferrule, at 230° C. or more and 260° C. or less for 1 minute or more.

The heat treatment process is preferably performed in a low-oxygen or oxygen-free atmosphere.

According to the second aspect of the present invention, the heat treatment at the temperature assuming solder reflow is performed on the ferrule that has been dimensionally designed in advance with an allowance for thermal shrinkage. Thus, thermal shrinkage in the reflow process can be suppressed.

Also, performing the heat treatment process in the low-oxygen or oxygen-free atmosphere can suppress changes in physical properties due to bonding between the resin and oxygen during the heat treatment, which is performed at a temperature that is quite high for a temperature for common resin heat treatment.

A third aspect of the present invention is a ferrule-equipped fiber ribbon using the ferrule according to the first aspect of the present invention, in which a plurality of optical fibers are inserted into a plurality of the holes, respectively, to be fixed to the ferrule with adhesive.

According to the third aspect of the present invention, the ferrule-equipped fiber ribbon that is less affected by shrinking during a reflow process can be obtained.

A fourth aspect of the present invention is a method for manufacturing a ferrule-equipped fiber ribbon, in which an optical fiber is fixed inside an optical connector ferrule whose tip side serves as a connection end surface. The ferrule is formed from a resin composition, which is thermoplastic resin added with a filling material including at least inorganic particles. The ferrule includes a plurality of holes into each of which the optical fiber is to be inserted, and a pair of guide holes into which guide pins for positioning are to be inserted. The method includes performing a heat treatment on the ferrule at 230° C. or more and 260° C. or less for 1 minute or more, inserting the optical fiber into the ferrule, injecting adhesive from an adhesive injection window to fix the optical fiber to the ferrule, and polishing a tip end surface of the ferrule to make the optical fiber protrude for a predetermined length or more from an end surface of the ferrule.

The method may also include performing a heat treatment at 230° C. or more and 260° C. or less for 1 minute or more after the polishing process. In such the case, an amount of protrusion of the optical fiber from the end surface of the ferrule after the polishing and before the heat treatment is preferably 5 μm or more.

The method may also include performing a heat treatment at 230° C. or more and 260° C. or less for 1 minute or more before the polishing process.

According to the fourth aspect of the present invention, the ferrule-equipped fiber ribbon that is less affected by shrinking during the reflow process can be obtained.

Also, by making the tip end of the optical fiber protrude from the end surface of the ferrule for the predetermined amount in advance at the time of polishing, PC connection of optical fiber cores is possible even if there is retraction due to shrinking of adhesive at the time of the heat treatment after polishing.

Also, performing the heat treatment in a state in which the optical fiber protrudes for the predetermined amount from the end surface followed by polishing can make the amount of protrusion of the optical fiber from the ferrule adequate.

A fifth aspect of the present invention is a method for manufacturing a ferrule-equipped fiber ribbon, in which an optical fiber is fixed inside an optical connector ferrule whose tip side serves as a connection end surface. The ferrule is formed from a resin composition, which is thermoplastic resin added with a filling material including at least inorganic particles. The ferrule includes a plurality of holes into each of which the optical fiber is to be inserted, and a pair of guide holes into which guide pins for positioning are to be inserted. The method includes inserting the optical fiber into the ferrule, injecting adhesive from an adhesive injection window to fix the optical fiber to the ferrule, polishing a tip end surface of the ferrule to make the optical fiber protrude for a predetermined length or more from an end surface of the ferrule, and performing a heat treatment on the ferrule at 230° C. or more and 260° C. or less for 1 minute or more after the polishing process.

In such the case, an amount of protrusion of the optical fiber from the end surface of the ferrule after the polishing and before the heat treatment is preferably 5 μm or more.

According to the fifth aspect of the present invention, by making the tip end of the optical fiber protrude from the end surface of the ferrule for the predetermined amount in advance at the time of polishing, PC connection of optical fiber cores is possible even if there is retraction due to shrinking of adhesive at the time of heat treatment after the polishing.

A sixth aspect of the present invention is a method for manufacturing a ferrule-equipped fiber ribbon, in which an optical fiber is fixed inside an optical connector ferrule whose tip side serves as a connection end surface. The ferrule is formed from a resin composition, which is thermoplastic resin added with a filling material including at least inorganic particles. The ferrule includes a plurality of holes into each of which the optical fiber is to be inserted, and a pair of guide holes into which guide pins for positioning are to be inserted. The method includes inserting the optical fiber into the ferrule, injecting adhesive from an adhesive injection window to fix the optical fiber to the ferrule, performing a heat treatment on the ferrule at 230° C. or more and 260° C. or less for 1 minute or more, and polishing a tip end surface of the ferrule after the heat treatment to make the optical fiber protrude for a predetermined length or more from an end surface of the ferrule.

According to the sixth aspect of the present invention, performing the heat treatment in a state in which the optical fiber protrudes for the predetermined amount from the end surface followed by polishing can make the amount of protrusion of the optical fiber from the ferrule adequate.

The present invention can provide an optical connector ferrule and the like in which effects in a solder reflow process can be suppressed without using special resin material.

### BRIEF DESCRIPTION OF DRAWINGS

FIG. 1A is a perspective view showing an optical connector ferrule 1.

FIG. 1B is a cross-sectional view, taken in an axial direction, of the optical connector ferrule 1.

FIG. 2 is a flowchart showing a manufacturing process of the optical connector ferrule 1.

FIG. 3A is a cross-sectional view, taken in an axial direction, of a ferrule-equipped fiber ribbon, in which an optical fiber 17 is fixed with adhesive 19.

FIG. 3B is a cross-sectional view, taken in the axial direction, of the ferrule-equipped fiber ribbon after polishing an end surface of an optical ferrule.

FIG. 4 is a flowchart showing another manufacturing process of the optical connector ferrule 1.

FIG. 5A is a cross-sectional view, taken in the axial direction, of the ferrule-equipped fiber ribbon with a tip end of the optical fiber 17 being protruded by polishing.

FIG. 5B is a cross-sectional view, taken in the axial direction, of the ferrule-equipped fiber ribbon after a heat treatment.

FIG. 6 is a flowchart showing another manufacturing process of the optical connector ferrule 1.

### DETAILED DESCRIPTION

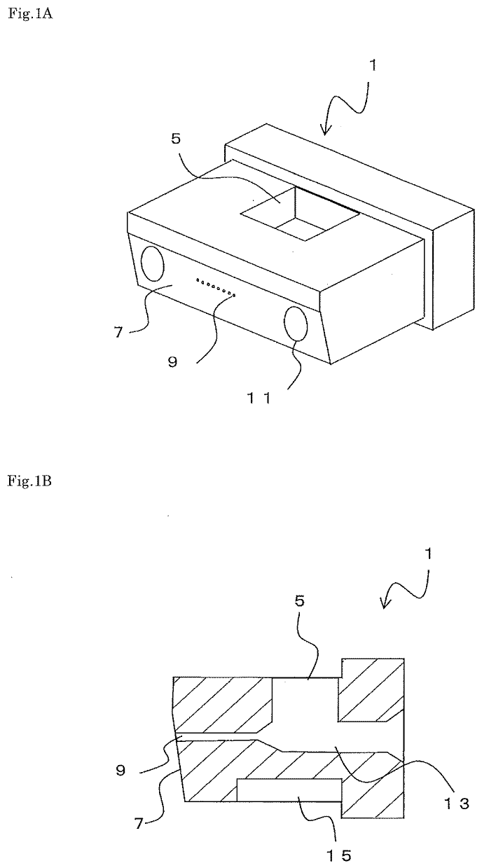

Hereinafter, an optical connector ferrule according to an embodiment of the present invention will be described. FIG. 1A is a perspective view showing an optical connector ferrule 1 and FIG. 1B is a cross-sectional view thereof. The optical connector ferrule 1 is a member inside which an optical fiber is to be fixed, with a tip side serving as a connection end surface 7 for the optical fiber. The optical connector ferrule 1 can be used as a mechanically transferrable connector (a so-called MT connector) having a guide hole 11.

An internal space 13 that accommodates the optical fiber is formed inside the optical connector ferrule 1. The internal space 13 penetrates from a rear end through to a tip end of the optical connector ferrule 1. An insertion side for the optical fiber of the optical connector ferrule 1 (the right side of FIG. 1B) is referred to as a rear end side, and a side where the end surface of the optical fiber is exposed (the left side of FIG. 1B) is referred to as a tip side. That is, a left-right direction of FIG. 1B is referred to as a tip-rear end direction (or a connection direction in some cases) of the optical connector ferrule 1.

The optical connector ferrule 1 is molded by injection molding, for example, and is formed from polyphenylene sulfide (PPS) resin including a filling material (e.g., an inorganic fiber or a filler).

The internal space 13 communicates with the tip side of the optical connector ferrule 1 and becomes a hole 9 through which the optical fiber is inserted. The present embodiment is a multiple-core connector ferrule in which a plurality of the optical fibers can be fixed being arranged side by side. That is, the connection end surface 7 is provided with a plurality of the holes 9 that are arranged side by side.

Also, the connection end surface 7 is a plane that is inclined to the connection direction. That is, the plurality of the holes 9 are disposed on an inclined surface. Also, a pair of the guide holes 11 are provided on both sides of the holes 9. Guide pins or the like for positioning with a connection target are to be inserted into the guide holes 11. The inclined surface of the connection end surface 7 is not always necessary and the connection end surface 7 may be vertical to the tip-rear end direction or may be a surface that is curved in some degree.

An adhesive injection window 5 opening outward is formed in an upper surface of the optical connector ferrule 1. The adhesive injection window 5 communicates with the internal space 13 and adhesive can be injected from the adhesive injection window 5 into the internal space 13.

Also, a dent section 15 is formed as necessary on an outer surface of the optical connector ferrule 1 on a side that is opposite to a side on which the adhesive injection window 5 is formed (i.e., a lower surface). The dent section 15 is formed to have a predetermined depth to the outer surface, and is not connected to the internal space 13. The dent section 15 is formed such that a reduced volume of the dent section 15 is substantially equivalent to a volume of a space between the adhesive injection window 5 and the internal space 13, for example.

As mentioned above, the optical connector ferrule 1 is formed by injection molding. That is, resin is injected from a predetermined position into a cavity of a metal mold, and a shape is molded according to the cavity shape. At this time, the melted resin flows from the injected position into the metal mold to fill the cavity.

If the resin is injected from the rear end side of the optical connector ferrule 1, for example, since the holes 9 and the internal space 13 are arranged in the substantially center in a vertical direction of the optical connector ferrule 1, the resin flows toward the tip side branching off to an upper side and a lower side of the internal space 13. At this time, on the upper side of the internal space 13, the adhesive injection window 5 is formed, which obstructs the flow of the resin. On the other hand, there is no adhesive injection window 5 at the lower side of the holes 9, and thus, when compared to the upper side of the holes 9, fluid resistance of the resin is smaller. Such an imbalance of the resin flow between the upper and lower sides of the holes 9 may deteriorate dimensional accuracy of the optical connector ferrule 1.

In contrast, providing the dent section 15 on the outer surface on the opposite side of the adhesive injection window 5 can reduce flow resistance or volume difference of the resin between the upper and lower sides of the internal space 13. Thus, the resin on the upper and lower sides can be well balanced, which can improve the dimensional accuracy of the optical connector ferrule 1. However, the dent section 15 is not essential.

Here, the optical connector ferrule 1 is formed from a resin composition that is made by adding a filler material including at least inorganic particles to thermoplastic resin. Although not particularly limited, polyphenylene sulfide (PPS) resin, polycarbonate (PC) resin, polyethersulfone (PES) resin, liquid crystal polymer (LCP), modified polyphenylene ether (PPE) resin, and the like are applicable to the thermoplastic resin, and it is preferable to use PPS resin as a main component in views of dimensional stability, strength, molding performance, and the like. PPS resin may have a cross-linked or straight-chain structure, and the structure, molecular weight, etc. thereof may be suitably selected according to characteristics expected for the optical connector ferrule 1 to be used.

A linear expansion coefficient of the resin composition is preferably 3.0×10⁻⁵/° C. or less. If the linear expansion coefficient exceeds 3.0×10⁻⁵/° C., a relative position between the guide holes 11 and the holes 9 may shift due to changes in environment temperature, and an increase in connection loss due to such the shift cannot be ignored.

Also, a content rate of the inorganic particles in the resin composition is preferably 60 mass % or more and 80 mass % or less. Also, as the inorganic particles, although particles of silica or calcium carbonate are applicable, it is preferable to include spherical silica. This can stabilize thermal shrinkage and molding performance of the optical connector ferrule 1. For example, flat-shaped inorganic particles may prevent expansion and shrinkage of surrounding resin, and this may increase anisotropy. However, spherical shapes can suppress such anisotropy.

Also, a particle size distribution D100 (the maximum particle diameter) of the inorganic particles is preferably 60 μm or less. In particular, the cumulative 99% particle size D99 of the spherical silica particles is preferably 25 μm or less, more preferably 10 μm or less, and furthermore preferably 1 μm or less. This can prevent rough particles from being contained in the resin composition, which can prevent imbalance of microscopic (local) composition. The particle size of the inorganic particles can be obtained by particle size distribution measurement using a laser diffraction and scattering method, for example.

Also, the resin composition may further include carbon black as carbon particles. This can color the optical connector ferrule 1 black, which makes foreign substances inside the optical connector ferrule 1 less noticeable, thereby improving an appearance thereof.

Here, a shrinkage factor of the optical connector ferrule 1 of the present invention at 260° C.×1 minute is 0.13% or less. For example, a change rate of a pitch between the guide holes 11 before and after a heat treatment of 260° C.×1 minute is 0.13% or less. The shrinkage factor is calculated by (size before shrinkage-size after shrinkage)/size after shrinkage×100%.

In this way, even at a temperature between 230° C. and 260° C., which is a temperature condition for a reflow process of a common substrate, an amount of shrinkage of the optical connector ferrule 1 can be suppressed to a predetermined value or less. A method for reducing the shrinkage factor in the reflow process in this way will be described below.

Next, a method for manufacturing the optical connector ferrule 1 will be described. As mentioned above, the optical connector ferrule 1 is molded by injection molding. Next, after molding the optical connector ferrule 1, a heat treatment at 230° C. or more and 260° C. or less for 1 minute or more is performed by a heating furnace. For more stabilization, it is preferable to perform the heat treatment at 230° C. or more and 260° C. or less for 10 minutes or more.

Here, normally, the heat treatment (annealing) of thermoplastic resin generally aims for release etc. of inner stress at the time of molding and the like. Thus, in many cases, the heat treatment for non-crystalline resin is performed at a temperature that is slightly lower than a glass transition temperature Tg, and the heat treatment for crystalline resin is performed at a temperature that is slightly higher than the glass transition temperature. However, if the temperature is raised up to a melting point of the resin, the resin softens and a shape thereof cannot be maintained. Thus, for example, the glass transition temperature of PPS resin, which is a crystalline resin, is approximately 90° C. and thus it is common to perform the heat treatment at a temperature around Tg+20-+30° C.

However, in the present embodiment, the heat treatment is performed for 1 minute or more at a temperature set at 230° C. or more and 260° C. or less, which is far higher than the above temperature. For example, in regard to a melting point Tm=290° C. of PPS resin, a heat treatment condition is set at a temperature that is higher than (Tg+Tm)/2. Heating at a temperature that is impossible as the heat treatment condition of normal resin in this way can thermally shrink the resin with certainty. Note that the heat treatment temperature can be set according to a temperature in a scheduled reflow process.

Here, in a general annealing heat treatment of crystalline resin, crystalline parts and non-crystalline parts are mixed, and raising the temperature to around Tg+20-30° C. promotes crystallization of the non-crystalline parts to be stabilized. In the present embodiment, in contrast, the heat treatment is performed at a temperature that is closer to Tm rather than Tg, and thus the crystalline parts and non-crystalline parts move to be denser and shrinkage takes place. In this way, compared to resin without the heat treatment of the present embodiment, the amount of shrinkage in the following reheating (the reflow process) can be reduced.

Note that due to the shrinking through the heat treatment, the pitch between the guide holes 11 etc. is to be reduced, for example, and dimensions at the time of injection molding are to be set with an allowance for such the amount of thermal shrinkage in advance. That is, an expected dimensions after the heat treatment can be obtained by obtaining data in advance on the amount of thermal shrinkage under predetermined heat treatment conditions and designing a metal mold for injection molding so as to have intended dimensions by the shrinkage.

The heat treatment process is performed preferably in a low-oxygen or oxygen-free environment. For example, the heat treatment is performed preferably in a nitrogen atmosphere or under reduced-pressure conditions. Similarly, to eliminate effects of moisture, the heat treatment process is performed preferably in a dry atmosphere. Alternatively, the temperature may be held at 100° C. or more for drying before raising the temperature to the heat treatment temperature, and then the temperature may be raised to a predetermined temperature. This can suppress bonding between the resin composition and oxygen at the high temperature or changes in physical properties due to moisture.

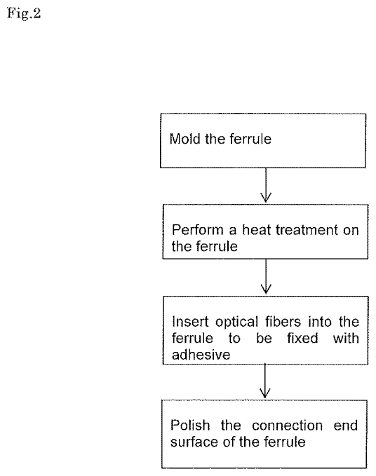

Next, a method for manufacturing a ferrule-equipped fiber ribbon, in which an optical fiber is fixed, using the optical connector ferrule 1 will be described. FIG. 2 is a view showing a manufacturing process of the ferrule-equipped fiber ribbon. As mentioned above, the optical connector ferrule 1 is molded by injection molding first and then a heat treatment is performed at a set temperature of 230° C. or more and 260° C. or less for 1 minute or more for pre-shrinking.

Next, an optical fiber is inserted from the rear end side of the optical connector ferrule 1. In such the state, adhesive is injected from the adhesive injection window 5 of the optical connector ferrule 1 to fix the optical fiber to the optical connector ferrule 1.

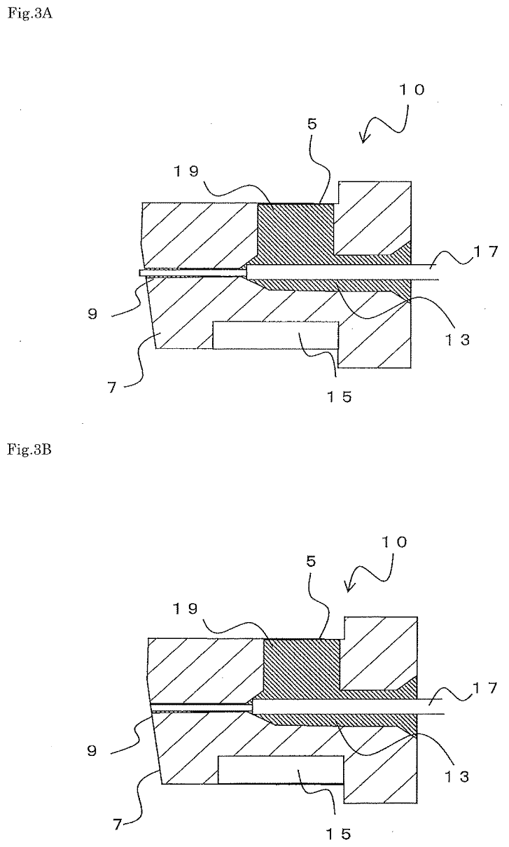

FIG. 3A is a cross-sectional view showing a ferrule-equipped fiber ribbon 10 in which the optical fiber 17 is fixed to the optical connector ferrule 1 with adhesive 19. The optical fiber 17 includes a glass-made internal optical fiber core and a resin layer formed around the optical fiber core. The resin layer in proximity of a tip end portion of the optical fiber 17 is removed to expose the internal optical fiber core, and then inserted through into the hole 9. The hole 9 is smaller than an outer diameter of the resin layer, and thus an end surface of the resin layer is butted against a tapered portion of the rear end side of the hole 9 so as to position the optical fiber 17.

The internal space 13 includes, in order from the rear end side of the optical connector ferrule 1, a first tapered portion that functions as a guide for inserting the optical fiber 17 etc. with a diameter thereof being reduced toward the tip side, a second tapered portion against which the resin layer is butted, that functions as an insertion guide for the optical fiber core, with a diameter thereof being reduced toward the tip side, and a hole 9 that is formed with substantially the same diameter through to the tip end.

When the adhesive 19 is injected from the adhesive injection window 5, the adhesive 19 is injected into the internal space 13. At this time, the adhesive injection window 5 has a sufficient opening area, which facilitates injection of the adhesive. Although thermosetting resin such as epoxy resin is applicable as the adhesive 19, types of adhesive are not particularly limited and UV curable resin etc. may also be used.

The optical fiber 17 can be fixed to the optical connector ferrule 1 by curing the adhesive 19 in such the state. In such the state, a tip end of the optical fiber 17 is made to protrude from the connection end surface 7. Finally, as shown in FIG. 3B, the connection end surface 7 is polished together with the optical fiber 17. To perform a PC connection when connectors are connected to each other, the polishing is performed such that an end surface of the optical fiber 17 slightly (approximately 1-3.5 μm) protrudes from the connection end surface 7 after the polishing. In this way, the ferrule-equipped fiber ribbon can be obtained.

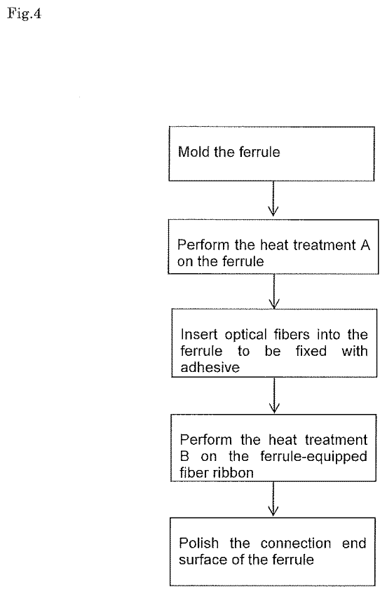

Although the above description shows a method in which the optical fiber is fixed to the optical connector ferrule 1 that has been heat treated in advance, the method is not limited thereto. FIG. 4 is a view showing another manufacturing process of the ferrule-equipped fiber ribbon.

In the present embodiment, as mentioned above, the optical connector ferrule 1 is molded by injection molding followed by the above-mentioned heat treatment A for pre-shrinking (at a set temperature of 230° C. or more and 260° C. or less for 1 minute or more), and then the optical fiber 17 is inserted into the optical connector ferrule 1 to be fixed with the adhesive 19.

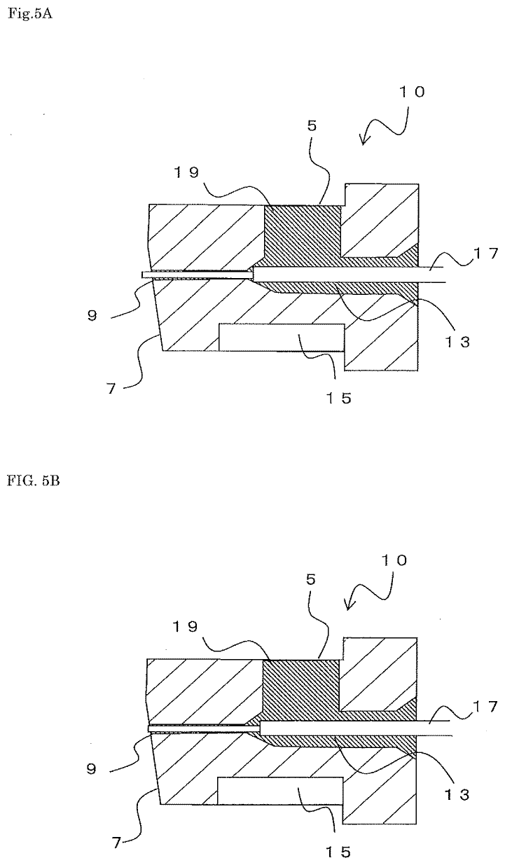

FIG. 5A is a view showing the ferrule-equipped fiber ribbon 10 in which the optical fiber 17 is fixed to the optical connector ferrule 1 with the adhesive 19. Unlike the above-mentioned manufacturing process, a protruding length of the optical fiber 17 from the connection end surface 7 is made longer in a state in which the optical fiber 17 is fixed to the optical connector ferrule 1.

In such the state, a heat treatment B at 230° C. or more and 260° C. or less for 1 minute or more is performed on the ferrule-equipped fiber ribbon. Here, in the ferrule-equipped fiber ribbon 10, an amount of shrinkage of the adhesive 19 is larger than that of the optical connector ferrule 1 in the above heat treatment. In such the case, as shown in FIG. 5B, the optical fiber 17 is pulled backward due to shrinking of the adhesive 19 and the tip end of the optical fiber 17 is retracted into the optical connector ferrule 1.

After such the heat treatment B, the tip end surface of the optical connector ferrule 1 is polished together with the optical fiber 17. As mentioned above, the polishing is performed such that an end surface of the optical fiber 17 slightly (approximately 1-3.5 μm) protrudes from the connection end surface 7 after the polishing. In this way, the ferrule-equipped fiber ribbon 10 can be obtained.

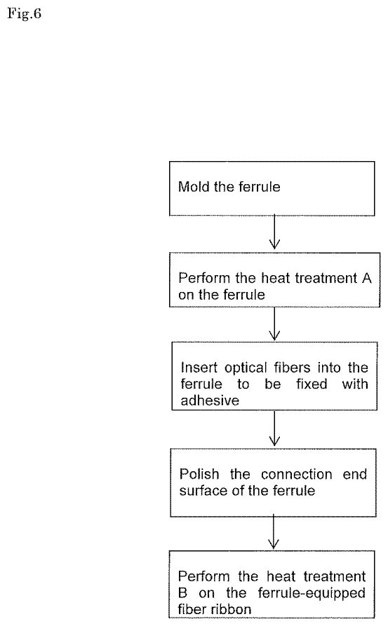

Timing of the polishing may also be changed. FIG. 6 is a view showing another manufacturing process of the ferrule-equipped fiber ribbon. In an example shown in FIG. 6, after the heat treatment A is performed, the adhesive 19 is injected from the adhesive injection window 5 to fix the optical fiber 17 to the optical connector ferrule 1. Then, before performing the above-mentioned heat treatment B for pre-shrinking, the tip end surface of the optical connector ferrule 1 is polished to protrude the optical fiber 17 a predetermined length or more from the end surface of the ferrule. For example, an amount of protrusion of the optical fiber 17 from the end surface of the optical connector ferrule 1 after the polishing and before the heat treatment is to be 5 μm or more.

Here, normally, the end surface of the optical connector ferrule is polished with high precision by starting from rough polishing and reducing abrasive particle size in steps. At this time, to make the optical fiber protrude 5 μm or more from the end surface of the optical connector ferrule, for example, the abrasive particle size of an abrasive used and polishing time in the final buffing are to be adjusted.

After the polishing, from a state in which the amount of protrusion of the optical fiber 17 from the end surface of the optical connector ferrule is constant with high precision, the heat treatment at 230° C. or more and 260° C. or less for 1 minute or more is performed on the ferrule-equipped fiber ribbon. As mentioned above, due to shrinking of the adhesive 19 (difference in heat shrinkage between the adhesive 19 and the optical connector ferrule 1) by the heat treatment, the tip end of the optical fiber 17 is retracted into the optical connector ferrule 1. For example, by checking such the retraction amount in advance, the amount of protrusion of the optical fiber 17 from the end surface of the optical connector ferrule after the retraction can be made approximately 1-3.5 μm. For example, if the amount of retraction by the heat treatment is approximately 8 μm, the optical fiber is made to protrude approximately 10 μm from the end surface of the optical connector ferrule by the prior polishing.

As above, according to the present embodiment, by performing the heat treatment, which is equivalent to a reflow process, for thermal shrinkage on the optical connector ferrule in advance before being installed on a substrate and sent to the reflow process, effects of shrinkage during the reflow process can be reduced. Thus, dimensions after shrinkage due to reflow can be checked before being installed on the substrate, and this can suppress dimensional defects due to shrinkage after the reflow process.

Also, it is unnecessary to use special resin and thus the cost is low. In addition, for example, there is no significant change in the linear expansion coefficient with an optical connector made of PPS or the like, which is a connection target, and thus an increase in optical loss due to environment temperature can be suppressed.

Also, since fine inorganic particles are added adequately, deformation at the time of heat treatment can be suppressed, thereby ensuring strength and dimensional stability.

Also, in manufacturing the ferrule-equipped fiber ribbon, the heat treatment is performed after the optical fiber 17 is fixed with the adhesive 19, and thus it is possible to shrink not only the optical connector ferrule 1 but also the adhesive 19. Thus, in the reflow process, it is possible to stabilize the pitch of the optical fiber 17 and the protrusion amount of the optical fiber 17 from the end surface of the optical connector ferrule 1.

In the processes shown in FIG. 4 and FIG. 6, the heat treatment A may be omitted. In such the case, the same effects as in the heat treatment A (pre-shrinking effects of the optical connector ferrule 1) can be obtained simultaneously in the heat treatment B only. However, if it is necessary to extend heat treatment time of the heat treatment A (e.g., 230° C.-260° C.×10 minutes or more is necessary for more stabilized effects), it is preferable that conditions for the heat treatment B are to be 230° C.-260° C.×10 minutes or more, or that both the heat treatment A and heat treatment B are to be performed.

Although the embodiments of the present invention have been described referring to the attached drawings, the technical scope of the present invention is not limited to the embodiments described above. It is obvious that persons skilled in the art can think out various examples of changes or modifications within the scope of the technical idea disclosed in the claims, and it will be understood that they naturally belong to the technical scope of the present invention.

### Working Example

### (Shrinkage Factor)

Optical connector ferrules were actually manufactured to check shrinkage amounts at the time of heat treatment that was intended as a reflow process. PPS added with spherical silica was used as the resin composition. When the heat treatment A of 260° C.×1 minute was performed in a heating furnace after injection molding, the shrinkage factors (measured with a guide-hole pitch distance (=4.6 mm)) were in a range of from 0.15% to 2.0%. When a heat treatment of 260° C.×1 minute was performed once again in the heating furnace after cooling, all the shrinkage factors to the dimensions after the heat treatment A were 0.13% or less.

From the above results, since a holding time in an actual reflow process in general is 1 minute or so, the optical connector ferrule without the heat treatment A may shrink more greatly when being put into the reflow process (e.g., 260° C.×1 minute). However, it is found that the shrinkage at the time of the reflow process can be suppressed after the heat treatment A has been performed.

If the heat treatment A (pre-heat treatment) is not performed as above, there may be occurrence of large shrinkage or variation during the reflow process.

On the other hand, with the heat treatment A (pre-heat treatment) being performed, the shrinkage factor in the following heat treatment (the reflow process) is smaller with less variation. Thus, by molding the ferrule taking into account the shrinkage amount in the heat treatment A, standard dimensions can be satisfied after the shrinking. Also, by eliminating those do not meet the standard dimensions after the heat treatment A, it is possible to suppress the ferrule from getting off the standard dimensions after the following reflow process.

When the time for the heat treatment A was varied to evaluate the shrinkage factor by time, the shrinkage factor remained unchanged and became almost constant after 10 minutes or more. As mentioned above, sufficient effects of pre-heat treatment can be seen just after 1 minute of the heat treatment A. However, for more stabilized pre-heat treatment effects, the heat treatment A of 10 minutes or more is preferable.

### (Amount of Retraction)

Optical fibers were fixed with adhesive to the optical connector ferrule after the heat treatment A, and were polished to have protrusion amounts of 1-3.5 μm. Then, the heat treatment B at 260° C.×1 minute was performed in the heat furnace and amounts of retraction of the optical fibers after the heat treatment B were evaluated.

As a result, although the amounts of retraction varied depending on positions of the optical fibers (the holes), the amount of retraction was around 4-6 μm on end sides in a side-by-side direction (sides closer to the guide holes) and the amount of retraction was around 6-10 μm in proximity of the center in a width direction. This may be because the shrinkage of the adhesive affects more at the proximity of the center part that is away from wall surfaces of the internal space of the optical connector ferrule. Thus, the optical fibers are to be polished taking into account the amount of retraction depending on the positions so that the amount of protrusion of the optical fiber at the center gradually increases. In this way, the amount of protrusion of the tip end of the optical fiber after the heat treatment B can be within a predetermined range.

The same effects can be obtained by performing the heat treatment B only, without the heat treatment A. For example, optical fibers were fixed with adhesive to the optical connector ferrule without the heat treatment A, and were polished to have protrusion amounts of 1-3.5 μm. If the heat treatment of 260° C.×1 minute was then performed in the heat furnace, almost the same effects as in the case in which both the heat treatment A and B were performed can be obtained.

What is claimed is:

1. An optical connector ferrule inside which an optical fiber is fixed, the ferrule having a tip side serving as a connection end surface, the ferrule comprising:
a hole into which the optical fiber is to be inserted; and
a pair of guide holes into which guide pins for positioning are to be inserted, wherein
the ferrule is formed from a resin composition, which is thermoplastic resin added with a filling material including at least inorganic particles; and
a shrinkage factor of the ferrule at 260° C.×1 minute is 0.13% or less.

2. The ferrule according to claim 1, wherein a linear expansion coefficient of the resin composition is 3.0×10⁻⁵/° C. or less.

3. The ferrule according to claim 1, wherein:
the thermoplastic resin includes PPS resin as a main component; and
the inorganic particles include spherical silica.

4. The ferrule according to claim 1, wherein a content rate of the inorganic particles in the resin composition is 60 mass % or more and 80 mass % or less.

5. The ferrule according to claim 1, wherein a particle size distribution D100 of the inorganic particles is 60 μm or less.

6. The ferrule according to claim 1, wherein the resin composition further includes carbon black as carbon particles.

7. The ferrule according to claim 1, wherein a dent section is formed in an outer surface of the ferrule on a side that is opposite to a side in which an adhesive injection window is formed.

8. A method for manufacturing the ferrule according to claim 1, the method comprising:
a heat treatment process, after molding the ferrule, at 230° C. or more and 260° C. or less for 1 minute or more.

9. A method for manufacturing the ferrule according to claim 8, wherein the heat treatment process is performed in a low-oxygen or oxygen-free atmosphere.

10. A ferrule-equipped fiber ribbon using the ferrule according to claim 1, wherein an optical fiber is inserted into each of a plurality of the holes to be fixed to the ferrule with adhesive.

11. A method for manufacturing a ferrule-equipped fiber ribbon in which an optical fiber is fixed inside an optical connector ferrule whose tip side serves as a connection end surface, the ferrule formed from a resin composition, which is thermoplastic resin added with a filling material including at least inorganic particles, comprising:
a plurality of holes into each of which the optical fiber is to be inserted; and
a pair of guide holes into which guide pins for positioning are to be inserted, and
the method comprising:
performing a heat treatment on the ferrule at 230° C. or more and 260° C. or less for 1 minute or more;
inserting the optical fiber into the ferrule;
injecting adhesive from an adhesive injection window to fix the optical fiber to the ferrule; and
polishing a tip end surface of the ferrule to make the optical fiber protrude for a predetermined length from an end surface of the ferrule.

12. The method for manufacturing the ferrule-equipped fiber ribbon according to claim 11, further comprising performing a heat treatment at 230° C. or more and 260° C. or less for 1 minute or more after the polishing process.

13. The method for manufacturing the ferrule-equipped fiber ribbon according to claim 12, wherein an amount of protrusion of the optical fiber from the end surface of the ferrule after the polishing and before the heat treatment is 5 μm or more.

14. The method for manufacturing the ferrule-equipped fiber ribbon according to claim 11, further comprising performing a heat treatment at 230° C. or more and 260° C. or less for 1 minute or more before the polishing process.

15. A method for manufacturing a ferrule-equipped fiber ribbon, in which an optical fiber is fixed inside an optical connector ferrule whose tip side serves as a connection end surface, the ferrule formed from a resin composition, which is thermoplastic resin added with a filling material including at least inorganic particles, comprising:
a plurality of holes into each of which the optical fiber is to be inserted; and
a pair of guide holes into which guide pins for positioning are to be inserted, and
the method comprising:
inserting the optical fiber into the ferrule;
injecting adhesive from an adhesive injection window to fix the optical fiber to the ferrule;
polishing a tip end surface of the ferrule to make the optical fiber protrude for a predetermined length or more from an end surface of the ferrule; and
performing a heat treatment on the ferrule at 230° C. or more and 260° C. or less for 1 minute or more after the polishing process.

16. The method for manufacturing the ferrule-equipped fiber ribbon according to claim 15, wherein an amount of protrusion of the optical fiber from the end surface of the ferrule after the polishing and before the heat treatment is 5 μm or more.

17. A method for manufacturing a ferrule-equipped fiber ribbon, in which an optical fiber is fixed inside an optical connector ferrule whose tip side serves as a connection end surface, the ferrule formed from a resin composition, which is thermoplastic resin added with a filling material at least inorganic particles, comprising:
a plurality of holes into each of which the optical fiber is to be inserted; and
a pair of guide holes into which guide pins for positioning are to be inserted, and
the method comprising:
inserting the optical fiber into the ferrule;
injecting adhesive from an adhesive injection window to fix the optical fiber to the ferrule;
performing a heat treatment on the ferrule at 230° C. or more and 260° C. or less for 1 minute or more; and
polishing a tip end surface of the ferrule after the heat treatment to make the optical fiber protrude for a predetermined length from an end surface of the ferrule.
